(19) United States
(12) Patent Application Publication
(10) Pub. No.: US 2012/0137826 A1
(43) Pub. Date: Jun. 7, 2012

(54) Supplementary Device for Bicycle Pedal and Bicycle Pedal Using the Same

(75) Inventor: Wen-Hwa Lin, Taichung City (TW)

(73) Assignee: VP COMPONENTS CO., LTD., Taichung Hsien (TW)

(21) Appl. No.: 12/959,724

(22) Filed: Dec. 3, 2010

(51) Int. Cl. B62M 3/08; B62M 3/16

(52) U.S. Cl. 74/594.6

(57) ABSTRACT

A bicycle pedal includes a pedal body having a spindle on the middle and two side frames at two opposite sides; a toe clip having a curved, flexible clip body, a through hole located on the top side for the insertion of a toe strap that is mounted in the pedal body and a mounting block located on the bottom side and movably connected to one side frame of the pedal body; and a supplementary device movably connected to the other side frame of the pedal body and having a guide face curving in direction away from the toe clip.

### BACKGROUND OF THE INVENTION

1. Field of the Invention

The present invention relates to bicycle pedal technology and more particularly, to a bicycle pedal, which has a toe clip and a toe strap arranged at one side of a pedal body and a supplementary device arranged at the other side of the pedal body to adjust the center of gravity of the bicycle pedal and to provide a guide face that facilitates insertion of the tip of the shoe into the inside of the toe clip.

2. Description of the Related Art

Taiwan Patent No. 76368 discloses a toe clip for use with toe straps in a bicycle pedal. The toe clip comprises a curved, flexible clip body, a through hole located on the top side for the insertion of the toe strap that is mounted in the bicycle pedal, and a mounting block located on the bottom side for fastening to one side of the bicycle pedal by screws. The toe clip defines therein an accommodation space for accommodating the tip of the shoe and the user's toes. After insertion of the tip of the shoe into the toe clip, the toe strap is fastened up to secure the shoe to the bicycle pedal.

According to the aforesaid prior art design, the toe clip is located on one side of the bicycle pedal, causing shift of the center of gravity of the bicycle pedal from the spindle of the bicycle pedal toward the side of the toe clip. Thus, the open side of the toe clip is normally kept upwards or forwards, as shown in FIG. 1. When the user is going to insert the tip of the shoe into the toe clip, the user must turn the bicycle pedal to horizontal with the hands for allowing insertion of the tip of the shoe into the inside of the toe clip. Therefore, the installation of the toe clip makes the use of the bicycle pedal inconvenient.

### SUMMARY OF THE INVENTION

The present invention has been accomplished under the circumstances in view. It is one object of the present invention to provide a bicycle pedal with a supplementary device, which eliminates the drawbacks of the aforesaid prior art design.

To achieve this and other objects of the present invention, a bicycle pedal comprises a pedal body having a spindle located on the middle and two opposing side frames located on two opposite sides relative to the spindle and rotatable with the spindle; a toe clip comprising a curved, flexible clip body, at least one through hole located on a top side thereof for the insertion of a toe strap that is mounted in the pedal body, and a mounting block located on a bottom side thereof and movably connected to one side frame of the pedal body; and a supplementary device movably connected to the other side frame of the pedal body, the supplementary device comprising a guide face curving in direction away from the toe clip. Further, the supplementary device comprises a connection plate, at least one screw member inserted through the connection plate and fastened to the other side frame of the pedal body to movably secure the connection plate to the other side frame. The connection plate comprises a guide panel curving in direction away from the toe clip and defining the guide face.

Subject to the installation of the supplementary device, the center of gravity of the whole bicycle pedal is relatively adjusted to keep the open side of the toe clip backwards or backwardly upwards, avoiding overturn of the bicycle pedal due to the effect of the weight of the toe clip.

Further, the design of the guide face of the guide panel of the supplementary device increases the contact area with the shoe, enabling the user to bias the bicycle pedal with the tip of the shoe to the angle that facilitates insertion of the tip of the shoe into the open side of the toe clip.

The supplementary device further comprises at least one counterweight detachably fastened to the connection plate to adjust the center of gravity of the bicycle pedal subject to the dimension, material or weight of the toe clip.

### BRIEF DESCRIPTION OF THE DRAWINGS

FIG. 1 is a schematic drawing illustrates a status of use of a conventional bicycle pedal.

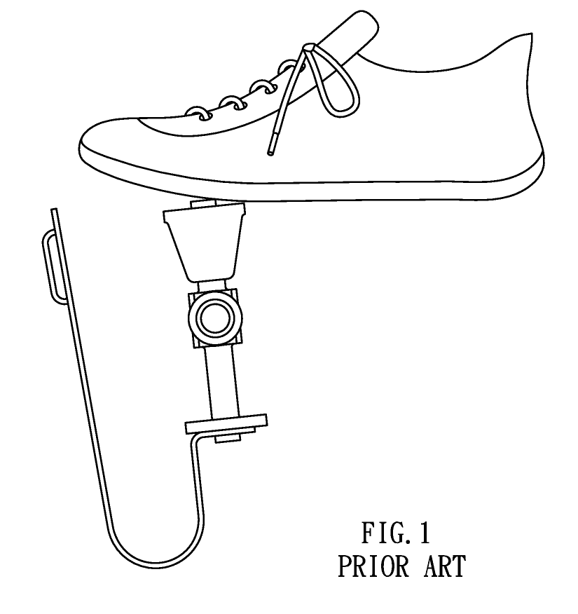

FIG. 2 is an exploded view of a bicycle pedal in accordance with the present invention.

FIG. 3 is an elevational assembly view of the bicycle pedal in accordance with the present invention.

FIG. 4 is a schematic drawing illustrating a status of use of the bicycle pedal in accordance with the present invention (I).

FIG. 5 is a schematic drawing illustrating a status of use of the bicycle pedal in accordance with the present invention (II).

FIG. 6 is a schematic drawing of the present invention, illustrating counterweights used with the supplementary device.

### DETAILED DESCRIPTION OF THE PREFERRED EMBODIMENT

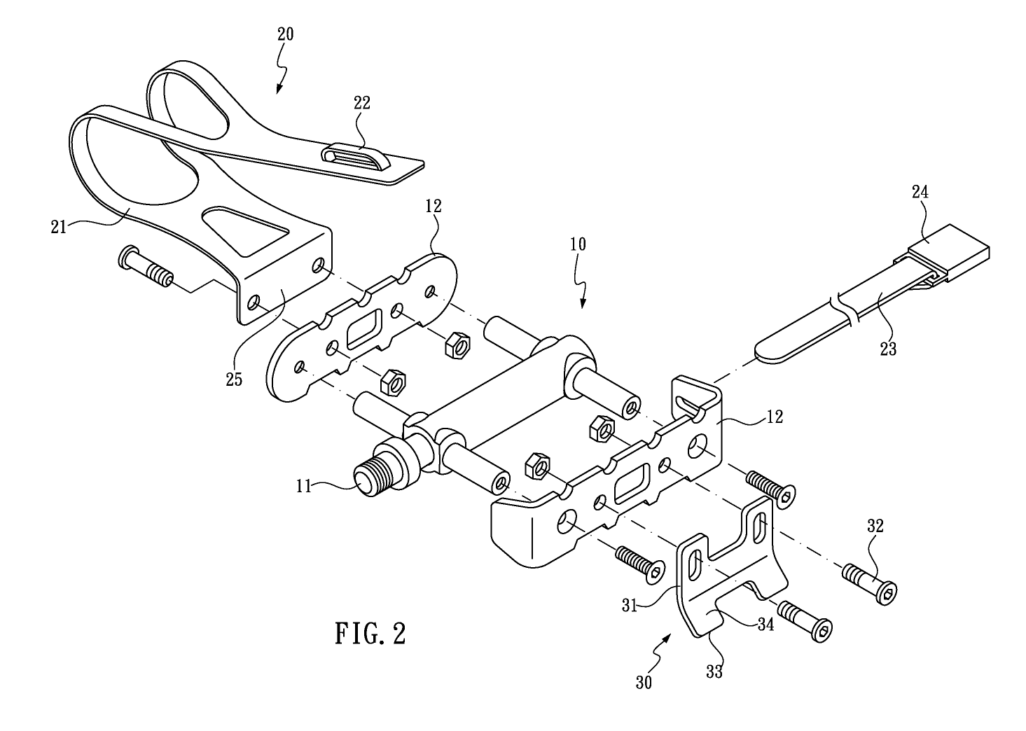

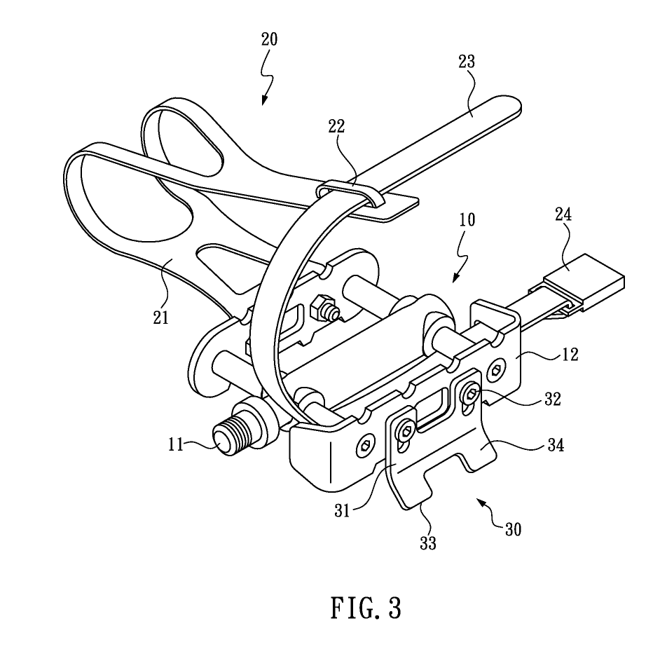

Referring to FIGS. 2 and 3, a pedal structure in accordance with the present invention is shown comprising a pedal body 10, a toe clip 20, and a supplementary device 30.

The pedal body 10 comprises a spindle 11 located on the middle and pivotally coupled to a pedal crank (not shown) for allowing free rotation of the pedal body 10 with the spindle 11 to facilitate pedaling the bicycle. The pedal body 10 further comprises two opposing side frames 12 which facilitate user's pedaling.

The toe clip 20 comprises a curved, flexible clip body 21, at least one through hole 22 located on the top side thereof for the insertion of a toe strap 23 that is mounted in the pedal body 10, a mounting block 25 located on the bottom side thereof and movably connected to one side frame 12 of the pedal body 10. The toe strap 23 has its one end mounted with a buckle 24 for receiving and locking the other end of the toe clip 23.

The supplementary device 30 comprises a connection plate 31, at least one screw member 32 inserted through the connection plate 31 and fastened to the other side frame 12 of the pedal body 10 to movably secure the connection plate 31 to the other side frame 12. The connection plate 31 comprises a guide panel 33 curving in direction away from the toe clip 20 and defining a guide face 34.

After understanding of the structural details, the operation and principle of the present invention are described hereinafter:

Subject to the installation of the supplementary device 30, the center of gravity of the whole assembly of the pedal body 10 and the toe clip 20 is shifted from a location near the toe clip 20 to a location near the spindle 11 of the pedal body 10 to avoid overturn of the pedal body 10 due to the effect of the weight of the toe clip 20 and to keep the open side of the toe clip 20 backwards or backwardly upwards, facilitating insertion of the shoe into the toe clip 20.

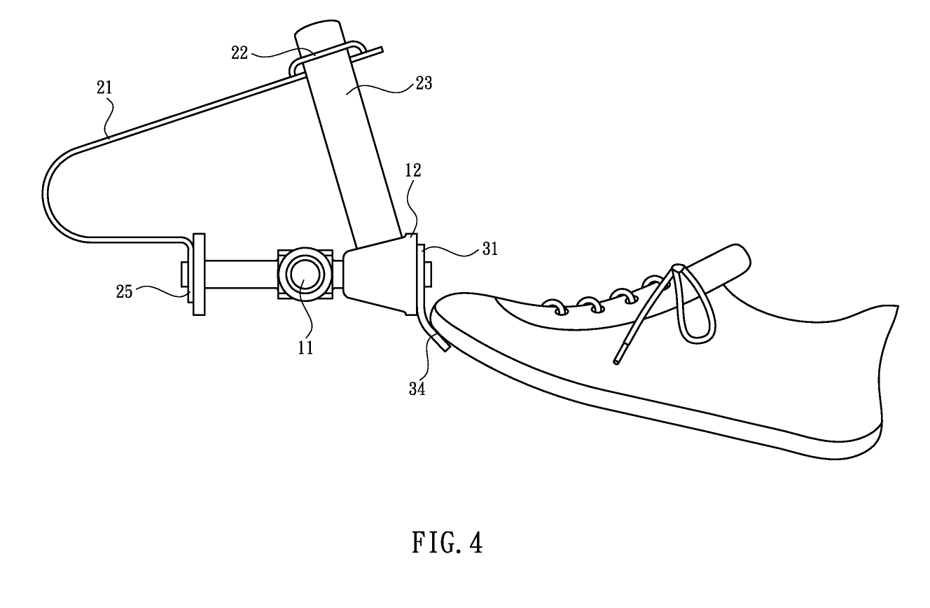

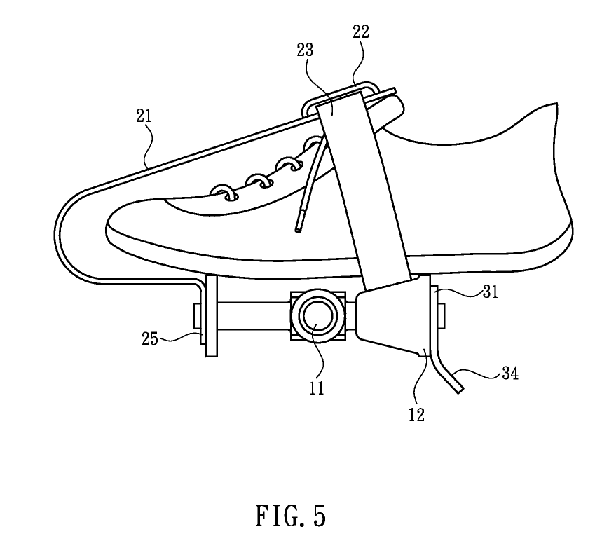

Further, if the pedal body 10 is not kept in horizontal due to the effect of an external pressure when the user is going to ride the bicycle, as shown in FIG. 4, the user can step the tip of the shoe on the guide face 34 of the guide panel 33 of the supplementary device 30 to turn the pedal body 10 to horizontal, and then the user can directly insert the tip of the shoe into the inside of the toe clip 20 and then wing the toe strap 23 round the shoe and then fasten tight the shoe to the pedal body 10 by means of the buckle 24 (see FIG. 5).

Subject to the installation of the supplementary device 30, the center of gravity of the whole bicycle pedal is relatively adjusted to keep the open side of the toe clip 20 backwards or backwardly upwards, avoiding overturn of the bicycle pedal due to the effect of the weight of the toe clip 20. Further, the design of the guide face 34 of the guide panel 33 of the supplementary device 30 increases the contact area with the shoe, enabling the user to bias the bicycle pedal with the tip of the shoe to the angle that facilitates insertion of the tip of the shoe into the open side of the toe clip 20.

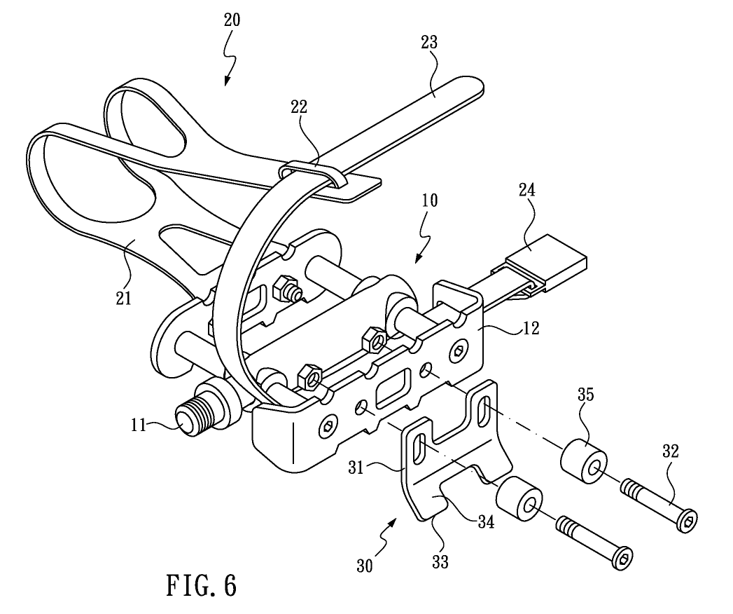

Referring to FIG. 6, at least one counterweight means 35 can be fastened to the connection plate 31 of the supplementary device 30 to adjust the center of gravity of the bicycle pedal subject to the dimension, material or weight of the toe clip 20. The counterweight 35 can be a weight fastened to the connection plate 31 of the supplementary device 30 by the at least one screw member 32.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bicycle pedal, comprising:
a pedal body having a spindle located on the middle and two opposing side frames located on two opposite sides relative to said spindle and rotatable with said spindle;
a toe clip comprising a curved, flexible clip body, at least one through hole located on a top side thereof for the insertion of a toe strap that is mounted in said pedal body, and a mounting block located on a bottom side thereof and movably connected to one said side frame of said pedal body; and
a supplementary device movably connected to the other said side frame of said pedal body, said supplementary device comprising a guide face curving in direction away from said toe clip.

2. The bicycle pedal as claimed in claim 1, wherein said supplementary device comprises a connection plate, at least one screw member inserted through said connection plate and fastened to said other side frame of said pedal body to movably secure said connection plate to said other side frame.

3. The bicycle pedal as claimed in claim 2, wherein said connection plate comprises a guide panel curving in direction away from said toe clip and defining said guide face.

4. The bicycle pedal as claimed in claim 1, said supplementary device further comprises at least one counterweight means detachably fastened to said connection plate to adjust the center of gravity of the bicycle pedal.

5. The bicycle pedal as claimed in claim 4, wherein each said counterweight means is a weight.

6. The bicycle pedal as claimed in claim 1, wherein said toe strap has one end thereof provided with a buckle, and an opposite end thereof fastenable to said buckle.

7. A supplementary device for use in a bicycle pedal, comprising:
a connection plate;
at least one screw member insertable through said connection plate and fastenable to a side frame of a bicycle pedal to movably secure said connection plate to said bicycle pedal; and
a guide panel extending from one end of said connection plate and defining a guide face.

8. The supplementary device as claimed in claim 7, said supplementary device further comprises at least one counterweight means detachably fastened to said connection plate to adjust the center of gravity of the bicycle pedal.

9. The bicycle pedal as claimed in claim 8, wherein each said counterweight means is a weight.
